(19) United States
(12) Patent Application Publication
(10) Pub. No.: US 2009/0294050 A1
(43) Pub. Date: Dec. 3, 2009

(54) OPTICAL CONTACTING ENHANCED BY HYDROXIDE IONS IN A NON-AQUEOUS SOLUTION

(75) Inventors: Nick Traggis, Boulder, CO (US); Christopher J. Myatt, Boulder, CO (US)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(73) Assignee: PRECISION PHOTONICS CORPORATION, Boulder, CO (US)

(21) Appl. No.: 12/233,911

(22) Filed: Sep. 19, 2008

Related U.S. Application Data
(60) Provisional application No. 61/057,634, filed on May 30, 2008.

(51) Int. Cl. B32B 37/12; B32B 37/00

(52) U.S. Cl. 156/275.5; 156/281

(57) ABSTRACT

This invention is a method of assembling precision optical or optomechanical components that provides first and second components having respective first and second polished contacting surfaces to be bonded; generates a hydrophilic surface on at least a portion of at least one of the first or second surfaces; rinses the hydrophilic portion with water or another suitable solvent; and contacts the hydrophilic portion of the first or second components with the respective contacting surfaces to be bonded, while maintaining alignment of the two components, to form a single structure

### CROSS-REFERENCE TO RELATED APPLICATION(S)

This application claims priority to U.S. provisional Application No. 61/057,634, filed May 30, 2008, entitled OPTICAL CONTACTING ENHANCED BY HYDROXIDE IONS IN A NON-AQUEOUS SOLUTION, that is incorporated herein by reference.

### BACKGROUND OF THE INVENTION

The bonding of materials is critical in making high performance instruments or devices. Depending on the particular application, the quality of a bonding method is judged on criteria such as bonding precision, mechanical strength, optical properties, thermal properties, chemical properties, and the simplicity of the bonding process. Three popular bonding methods of the prior art are optical contacting, epoxy bonding, and high temperature frit bonding. The salient features of each of these three prior art methods are summarized below.

Optical contacting is a room temperature process which employs no bonding material, and is thus suitable only for certain precision applications involving surfaces having reasonably good surface figure match. Ideally, if the bonding surfaces are thoroughly cleaned prior to bonding, the resulting interface will have low thermal noise and contain almost nothing susceptible to oxidation, photolysis, and/or pyrolysis. However, due to its sensitivity to surface particulate and chemical contamination (such as by air-borne contaminants) and other environmental factors (such as humidity), optical contacting produces bonds which are generally unreliable in strength. In addition, surface figure mismatch almost always exists to some extent. Consequently, strong chemical bonds rarely occur extensively across the interface, and voids are sometimes seen in the interface. Bonds produced by optical contacting do not consistently survive thermal shocks. Typically, optical contacting has a low first-try success rate. In case of failure, de-bonding usually degrades surface quality, and thus lowers success rate in re-bonding.

Epoxy bonding is usually a room temperature process and has a good success rate for regular room temperature applications. However, because epoxy bonding is typically organic based, the bonding is susceptible to pyrolysis (such as by high intensity lasers) and/or photolysis (such as by ultra-violet light) in high power density applications. The strength of the epoxy bond varies with temperature and chemical environment. Because the resulting wedge and thickness cannot always be precisely controlled, epoxy bonding is unsuitable for certain precision structural work. Epoxy bonding creates a relatively thick interface which makes optical index matching more of a concern in optical applications.

Frit bonding is a high-temperature process which creates a high-temperature rated interface. The interface is mechanically strong and chemically resistant in most applications. Because the frit material is physically thick and thus thermally noisy, it is unsuitable for precision structural work. For example, when optimized for bonding fused silica, frit bonding usually creates good coefficient of thermal expansion (CTE) matching with the bonded substrates at room temperature. The matching usually does not hold to a wider temperature range, however, resulting in strain and stress at or near the interface. Furthermore, a frit bond is opaque and inapplicable in transmission optics. Due to its high temperature requirement, frit bonding requires high temperature rated fixturing for alignment, and is thus expensive. Frit bonding is unsuitable if high temperature side effects, such as changes in the physical or chemical properties of the substrates, are of concern. Thus, each of the above prior art bonding methods has limitations and disadvantages.

More recently, other non-epoxy bonding methods have been introduced including the use of a hydroxide ion based bonding layer as described in U.S. Pat. Nos. 6,548,176 and 6,284,085 to Gwo that are both incorporated herein by reference, and the use of a thermal anneal assisted optical contacting device as described in U.S. Pat. No. 5,846,638 to Meissner and incorporated herein by reference. These two processes start to address some of the limitations of the standard optical contacting process described above, but also have their own drawbacks that this invention addresses.

### SUMMARY OF THE INVENTION

This is a method of assembling precision optical or optomechanical components that provides first and second components having respective first and second polished contacting surfaces to be bonded; generates a hydrophilic surface on at least a portion of at least one of the first or second surfaces; rinses the hydrophilic portion with water or another suitable solvent; and contacts the hydrophilic portion of the first or second components with the respective contacting surfaces to be bonded, while maintaining alignment of the two components, to form a single structure.

The present invention, in one embodiment, can be used to produce a precision beam splitter cube assembled with an optical thin film coated interface and no adhesives as illustrated in FIG. 1. The coating is deposited on polished prisms using ion beam sputtering to ensure it can withstand the application of the bonding agent without etching or surface degradation. The bonding agent is prepared as 5% potassium hydroxide w/v in isopropyl alcohol and the two coated prisms are immersed in the bonding agent for 5 minutes. The parts are then cleaned using a spin cleaning process and rinsed with DI water. They are spun until dry. The parts are then brought into contact and bonded. They are then annealed for 300° C. for 8 hours to improve bond strength. The advantages of this process over the current state of the art are as follows:

1) Forming a bond at the coated interface without epoxy or any adhesive.

2) Eliminating epoxy to allow higher laser damage thresholds, less scattering, and less absorption of the input light.

3) Eliminating epoxy to allow for a more precise coating design as the index is more consistent immersing in the bulk material. This allows better phase and dispersion control at the interface. This results in polarizing coatings with a wider angle acceptance, or non polarizing coatings with better phase matching.

4) Eliminating epoxy to allow for better transmitted wave front variation and mechanical tolerances. No wedge is induced by the bond line.

5) Eliminating epoxy to allow for prevention of out-gassing of materials in a vacuum or high temperature environment.

6) Depositing partial coatings on both “prism halves” and then bonding together creating a perfectly symmetrical coating design.

The present invention, in another embodiment, allows construction of a composite structures used as amplifier and oscillator assemblies in solid state pumped laser systems as illustrated in FIG. 2. For instance, this could include an Yb:YAG core with Sapphire cladding on each side. This can also be a laser rod or slab assembly where undoped or doped material is bonded to the ends of the rod or slab, or in a disk laser assembly where the laser is mounted on cladding on only one side. The cladding may be of undoped or doped material and may be arranged in numerous form factors and configurations depending on the desired performance and application. The cladding can act in a number of ways to improve laser action: it can act as a heat spreader, a quencher of parasitic oscillation, as mechanical support for mounting or handling, and as a low index cladding for light guiding. The slabs are polished on the broad faces to an optical quality polish and cleaned using acetone and deionized water. The bonding agent is prepared as 5% potassium hydroxide w/v in isopropyl alcohol and the slabs are immersed in the bonding agent for 5 minutes. The parts are then cleaned using a spin cleaning process and rinsed with deionized water. They are spun until dry. The parts are then brought into contact and bonded form a sandwich type assembly. They are then annealed for 300° C. for 8 hours to improve bond strength. The end faces can then be polished or coated as necessary depending on the laser design. The advantages to our process over the current state of the art are as follows:

1) Creating a structure as illustrated with no epoxy or adhesive residue.

2) Eliminating epoxy to allow for better transmitted wave front variation and mechanical tolerances. No wedge induced by the bond line. This is especially important in the fabrication of devices with tight tolerances on the active layer thickness as it can reference against the bond when polishing a second layer with no risk of mechanical error additions during polishing.

3) Eliminating epoxy to allow for prevention of out-gassing of materials in a vacuum or high temperature environment.

4) Using coated interfaces as a way to contain the evanescent wave in the device and to tailor the index of this coating for changing the wave guiding properties.

5) Using coated interfaces as a way to help match the CTE of two dissimilar materials as in the case of YAG to Sapphire. This allows the device to function over a wider temperature range without inducing unwanted stress.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is an electronic image of a beam splitter cube prepared with the method of this invention.

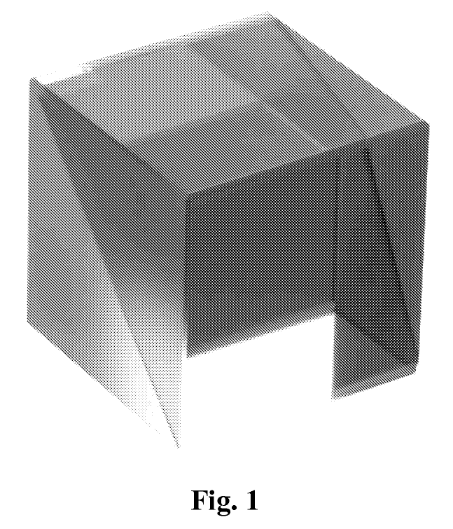

FIG. 2 is an electronic image of a composite wave guide structure prepared with the method of the present invention.

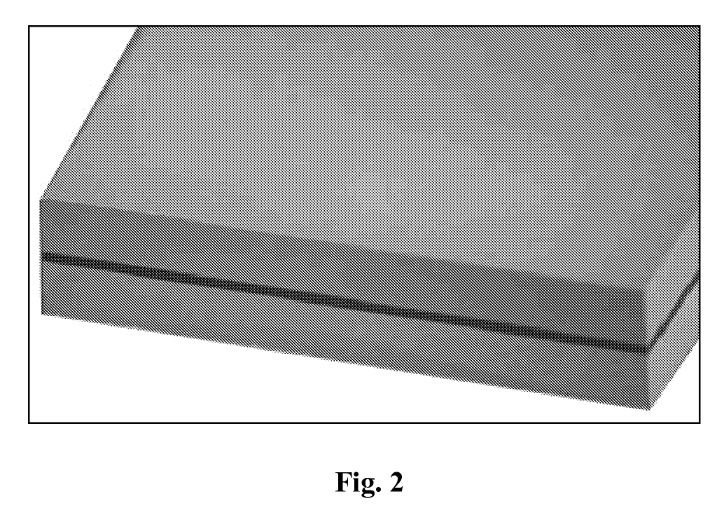

### DETAILED DESCRIPTION

This is a method of assembling precision optical or optomechanical components that provides first and second components having respective first and second polished contacting surfaces to be bonded; generates a hydrophilic surface on at least a portion of at least one of the first or second surfaces; rinse the hydrophilic portion with water or another suitable solvent; and contacts the hydrophilic portion of the first or second components with the respective contacting surfaces to be bonded, while maintaining alignment of the two components, to form a single structure. An example of such a process would be as follows:

One takes two 1″ diameter fused silica wafers that are ¼″ thick. The two wafers are polished on one side to a flatness of less than 0.100 um deviation across the surface with a surface roughness of approximately 12 angstroms rms. Looser specs could be used, but these are standard industry laser quality polishing levels. The current invention has been demonstrated to be successful on parts with roughness values up to 75 angstroms rms. Parts with flatness over 6 um out of flat have also been bonded when their aspect ratio is such that they are conformal to each other. (i.e., thinner parts don't have to be as flat as thicker parts for the process to work.) The parts are brought into a clean room environment (Class 1000) and are cleaned and dried with isopropyl alcohol (IPA), acetone, and de-ionized water.

The parts are then immersed into a solution of 5% potassium hydroxide in an isopropyl alcohol solvent for five minutes. The parts are removed from the solution and rinsed with deionized water or alkyl alcohols such as isopropyl alcohol and spun dry. (This removes any of the salt solution and prevents etching or staining of the surface.) The parts are then aligned and brought into contact with minimal pressure. The surfaces which are now quite hydrophilic will likely have a thin layer of water (monolayers) on them that form hydrogen bonds across the interface and the parts will adhere together with a contact wave observed as this occurs over 100% of the surface in contact. The parts are then placed in an annealing oven and brought to a temperature of 200° C. for several hours before being cooled to room temperature. The annealing schedule can be adjusted in both time and temperature depending on the materials be worked with and thermal exposure concerns. A part sitting at room temperature for an extended period of time will also yield the same result. The resultant dehydration that will occur at the bond interface will remove most of the water present and allow for O—Si—O bonds to occur across the bond interface on the now active silicate network on the bulk material surface. These bonds are very strong and result in the finished assembly with near bulk material strength. The polish quality and cleanliness of the bonding environment can be optimized to ensure full bond density and strength of the process.

The invention as described above lends itself well to most oxide based materials such as natural quartz, fused quartz, fused silica, ultra low thermal expansion glass, borosilicate, BK-7 glass, SF series of glasses, sapphire, and doped or undoped phosphate glasses, nonlinear crystals, and oxide based laser crystal materials. However some non-oxide based materials that form a native oxide or are otherwise compatible with the process such as silicon, germanium, GaAs, MgF₂, other fluorides, and ferroelectric materials have also been successfully bonded with this process.

Other materials that work well with the process are doped or undoped materials of ceramic or crystalline nature comprising Y₃Al₅O₁₂, Ca₂Al₂SiO₇, Gd₃Sc₂Al₃O₁₂, Y₃Sc₂Al₃O₁₂, CaY₄(SiO₄)₃O, Be₃Al₂Si₆O₁₈, Y_{3-X}Yb_{X}Al₅O₁₂, Nd_{X}Y_{1-X}Al₃(BO₃)₄, La_{1-X}Nd_{X}Mg_{X}Al_{12-X}O₁₉, Sr_{1-X}Nd_{X}Mg_{X}Al_{12-X}O₁₉, YAlO₃, BeAl₂O₄, Mg₂SiO₄, Y₃Fe₅O₁₂, Lu₃Al₅O₁₂, Al₂O₃, Y₂SiO₅ or CaCO₃. The lists above should be considered a guideline and not all-inclusive.

Enabling chemical activation from this process comes from creating a hydrophilic surface at the bond interfaces. The most straightforward way to do this is with a source of hydroxide ions such as found in solutions of calcium hydroxide, potassium hydroxide, sodium hydroxide, strontium hydroxide, sodium ethoxide, ammonium hydroxide, or potassium ethoxide dissolved in an organic solvent. It is preferred to use a non-aqueous solution as too much water being present could potentially prevent full dehydration of the bond interface and result in void formation due to volatilized water vapor. Tested solvents include both methanol and isopropanol.

Other non-liquid forms of surface activation have been demonstrated such as using a reactive ion plasma, or UV ozone. The goal of the chemical activation is to result in hydrophilic surfaces before bonding is initiated.

In some embodiments, one alternative includes cleaning the surfaces to be bonded to maximize bond density by eliminating any residue that could interfere with the process. Methods that have been validated include solvent rinsing as described above, solvent touch-off, ultrasonic cleaning, ozone/hydrogen peroxide cleaning, deionized air cleaning, CO₂ snow cleaning, spin cleaning with a cleaning agent or solvent, UV-ozone cleaning, and RCA Clean cleaning.

The dehydration after contact is initiated is also a critical step of the process. This will actually occur at room temperature in standard atmosphere if the assembly is left long enough, but in the interest of commercial viability, a faster more controlled method should be employed. This can be annealing in air or vacuum at a temperature below the glass transition temperature of the materials being bonded, or other more exotic methods such as UV or Microwave exposure to dehydrate the bond.

A proper bond will exhibit the following characteristics: the interface is transparent to wavelengths from deep UV to far infrared range, results in negligible optical loss (through absorption, scattering, or Fresnel reflections), and demonstrates a high strength as a fraction of the bulk strength of the material.

Other embodiments using this process include assembling precision optical components comprising a lens, an optical flat, a prism, an optical filter element, a window, a wave plate, a laser slab assembly, a wave guide, an optical fiber, a laser crystal, an optomechanical spacer, a fixture, a polarizing element, and/or a mirror. More specific examples include a prism/etalon assembly used in wavelength locking, or a wave plate/beam splitter assembly used for polarization beam combining.

The current invention also allows for bonding of optical components with a thin film coating at the interface to be bonded. The chemistry will have a mild etching effect so a more robust coating process such as that deposited with an ion assisted evaporation, ion beam sputtering, ion plating, or magnetron sputtering, deposition process is desired. The thin film coating comprises a dielectric material offering optical performance such as an anti-reflection coating, partial refection coating, mirror coating, band pass or dichroic filter coating, polarization control, dispertion control, wave guiding, or light-trapping. The beam splitter embodiment described previously is an example of this process.

The present invention provides bonding methods and compositions which have numerous advantages over prior art methods and materials. They are summarized below.

The present invention allows for the epoxy free bonding of interfaces that have an optical thin film present. This is because the process does not leave a residue that can stain or etch the coatings, such as the processes described under U.S. Pat. Nos 6,548,176 and 6,284,085. The high temperatures used in some of the prior art will also cause coating degredation due to the thermal expansion mismatch between the coating materials and the bulk substrate as potentially could occur under the process used in U.S. Pat. No. 5,846,638. The present invention does not require temperatures so high as to cause an issue here.

The present invention allows the bonding of chemically sensitive materials such as phosphate glasses and doped phosphate glasses. This is because the process does not leave a residue that can stain or etch the glass which would occur under processes described under U.S. Pat. Nos. 6,548,176 and 6,284,085. Phosphate glasses are often used in laser construction as they easily accept the dopants used as laser gain media.

The present invention allows the bonding of polished materials with higher surface roughness due to longer bond lengths enabled through the exposure to the bonding agent. Some of the prior art is limited to a surfaces with roughness better than 10 angstroms as indicated in the process reported in U.S. Pat. No. 5,846,638. The use of the described bonding agent also allows for better bond density and consistency of strength than the prior art.

The present invention results in bonds with very high mechanical shear strength. When breaking the bonds of fused silica to fused silica or YAG to YAG it is observed that the shear plane almost always goes across the bond interface without deflection. This demonstrates that the mechanical strength of the bond is similar to the bulk strength of the materials being bonded.

The present invention results in bonds that can withstand a very wide temperature range. YAG to YAG bonded laser slab assemblies have been produced that have been brought from room temperature to about 78° K. (immersed in liquid N₂). This same assembly was then heated from room temperature to 1000° C. with no degradation of the bonding interface observed. It should be noted that smaller temperature ranges will be observed when bonding materials of different CTE.

The present invention can be performed at room temperature in standard atmosphere by relatively unskilled personnel. The capital equipment is not expensive although a proper clean room environment is preferred for best performance.

The present invention offers a truly optically inert bonding interface. No loss, scattering or index change has been observed in any of the applications or embodiments referenced herein, including those at UV wavelengths.

The present invention has shown excellent long term stability and has passed accelerated aging tests from both the telecommunications and aerospace industries for deployed systems.

The present invention has been used in very high power laser systems exceeding 25 J/cm² through the bond interface. Coated bond interfaces have exceeded 12 J/cm² when used with a high quality ion beam sputtered coating.

The present invention results in a hermetic seal that is both waterproof and resistant to standard solvents such as acetone, isopropyl alcohol, and methanol. Other chemical resistances are expected but were not tested.

Other applications that are embodiments of the present invention would include the following:

Assemblies making use of non-linear quasi phase matching processes such as alternating crystal orientations of GaAs bonded in a long array.

Assemblies where a thin optical element is bonded to a thicker element to improve its surface figure or flatness by conforming to the thicker element. Examples would include a true zero order quartz wave plate bonded to a thicker piece of BK-7, or a thin disk laser assembly such as 200 um of Yb:YAG bonded to a 2 mm piece of undoped YAG or Sapphire. Post processing could even occur after bonding to bring the material to its final thickness.

Polarization beam-combiners can be formed by bonding a polarizing beam splitter as described above to a wave plate on one facet. The advantages using this process are higher damage threshold carrying capabilities, lower insertion loss, and lower transmitted wave front distortion due to zero bond line thickness.

Multi-element mirco-optic assemblies can also be created that allow for easier packaging and easier assembly. An etalon or other filter bonded to a beam splitter cube(s) is one such example. An example of this can be found in the “Single Etalon Wavelength Locker” reported in U.S. Pat. No. 6,621,580.

Another multi-element micro-optic assembly would be a multi-element filter where several solid filter substrates are bonded together with optical coatings at the interface. This process allows for very tightly controller thickness matching and parallelism which would be required in such a transmission optic.

Air-spaced etalons can be formed where low expansion glasses such as Zerodur or ULE are bonded to transmissive mirror elements. This forms a cavity stable with temperature changes and gives great flexibility in the free spectral range and finesse of the cavity be tailoring the mirror reflectivity and spacer length.

Compound wave plate structures could be formed taking two pieces of quartz of different thickness and bonding them together with this process to achieve the desired optical retardation.

Precision mechanical assemblies that can take advantage of the zero bond-line thickness and resultant zero wedge also benefit form this process even when optical considerations are not important.

The present invention could also be used to mount an optical or mechanical assembly to a polished non-optical mount made of metal, plastic, ceramic, or glass. In this case the bonding allows mounting the optical elements to such a heat spreader or mechanical mount.

Any optical or mechanical assembly that can benefit from lower absorption, higher fluence handling capabilities, zero bond line thickness, zero out-gassing, zero radiation susceptibility, and robust strength can benefit from this process.

Although the present invention has been described with reference to preferred embodiments, persons skilled in the art will recognize that changes may be made in form and detail without departing from the spirit and scope of the invention.

What is claimed is:

1. A method of assembling precision optical or optomechanical components comprising the steps of:
(a) providing first and second components to be bonded having respective first and second polished contacting surfaces;
(b) generating a hydrophilic surface on at least a portion of at least one of the first or second surfaces;
(c) rinsing the hydrophilic portion with water or alkyl alcohols; and
(d) contacting the hydrophilic portion of the first or second components with the respective contacting surfaces to be bonded, while maintaining alignment of the two components, to form a single structure

2. The method of claim 1, wherein the rinsing further comprises rinsing away residue on the at least a portion of the first or second surfaces.

3. The method of claim 1, wherein the first and second components are made up of oxide based materials such as natural quartz, fused quartz, fused silica, ultra low thermal expansion glass, borosilicate glasses, crown glass, SF series of glasses, sapphire, doped or undoped phosphate glasses, nonlinear crystals, or oxide based laser crystal materials.

4. The method of claim 1, wherein the first and second components are made up of non-oxide based materials that form a native oxide or are otherwise compatible with the process such as silicon, germanium, GaAs, MgF₂, other fluorides, or ferroelectric materials.

5. The method of claim 1, wherein the step of making a portion of the first or second surfaces hydrophilic further comprises applying a bonding component to a portion of the first or second surfaces.

6. The method of claim 5, wherein the bonding component is rinsed off, or the surfaces to be bonded are cleaned after hydrophilic surface generation.

7. The method of claim 5, wherein the bonding component comprises a source of hydroxide ions.

8. The method of claim 5, wherein the source of hydroxide ions comprises a non-aqueous source of hydroxide ions.

9. The method of claim 7, wherein the source of hydroxide ions comprises calcium hydroxide, potassium hydroxide, sodium hydroxide, strontium hydroxide, sodium ethoxide, ammonium hydroxide, or potassium ethoxide dissolved in an organic solvent.

10. The method of claim 9, wherein the organic solvent is methanol or isopropanol.

11. The method of claim 1, wherein the step of making at least a portion of the first or second surfaces hydrophilic comprises polishing the portions of the surface with an aqueous slurry with a pH greater than 8.

12. The method of claim 5, wherein the bonding component comprises a non-liquid bonding component.

13. The method of claim 12, wherein the non-liquid bonding component comprises a reactive ion plasma, or UV ozone.

14. The method of claim 1, further comprising the step cleaning at least one of the first or second surfaces to be bonded before making the first or second surface hydrophilic.

15. The method of claim 14, wherein the step of cleaning at least one of the first or second surfaces to be bonded includes at least one of solvent rinsing, solvent touch-off, ultrasonic cleaning, ozone/hydrogen peroxide cleaning, deionized air cleaning, CO₂ snow cleaning, spin cleaning with a cleaning agent or solvent, UV-ozone cleaning, or RCA Clean cleaning.

16. The method of claim 1, wherein at least one of the first and second surfaces is a doped or undoped materials or ceramic or crystalline nature comprising Y₃Al₅O₁₂, Ca₂Al₂SiO₇, Gd₃Sc₂Al₃O₁₂, Y₃Sc₂Al₃O₁₂, CaY₄(SiO₄)₃O, Be₃Al₂Si₆O₁₈, Y_{3-X}Yb_{X}Al₅O₁₂, Nd_{X}Y_{1-X}Al₃(BO₃)₄, La_{1-X}Nd_{X}Mg_{X}Al_{12-X}O₁₉, Sr_{1-X}Nd_{X}Mg_{X}Al_{12-X}O₁₉, YAlO₃, BeAl₂O₄, Mg₂SiO₄, Y₃Fe₅O₁₂, Lu₃Al₅O₁₂, Al₂O₃, Y₂SiO₅, or CaCO₃.

17. The method of claim 1, wherein a final curing step is performed in air or vacuum at a temperature in the range of 0° C. up to less than the melting point of the material be bonded.

18. The method of claim 1, wherein a final curing step is performed using a UV source or microwave radiation.

19. The method of claim 1, wherein the bonding interface is transparent to wavelengths from deep UV to far infrared range and the bonding interface results in negligible optical loss to the first and second components.

20. The method of claim 1, wherein the precision optical component comprises one or more of a lens, an optical flat, a prism, an optical filter element, a window, a wave plate, a laser slab assembly, a wave guide, an optical fiber, a laser crystal, an optomechanical spacer, a fixture, a polarizing element, or a mirror.

21. The method of claim 1, wherein the contacting surfaces have a surface roughness of less than 75 angstroms.

22. The method of claim 1, wherein the surfaces to be bonded have a thin film coating at the interface.

23. The method of claim 22, wherein the thin film coating is deposited with a deposition process comprising ion assisted evaporation, ion beam sputtering, ion plating, or magnetron sputtering.

24. The method of claim 22, wherein the thin film coating comprises a dielectric material offering optical performance comprising an anti-reflection coating, partial refection coating, mirror coating, band pass or dichroic filter coating, polarization control, dispertion control, wave guiding, or light-trapping.

25. The method of claim 22, wherein the thin film coating is deposited onto an otherwise non-compatible surface in order to improve the affinity for bonding wherein the surface comprises a polished metal, glass, ceramic, or plastic.
